(19) United States
(12) Patent Application Publication
(10) Pub. No.: US 2011/0008063 A1
(43) Pub. Date: Jan. 13, 2011

(54) TONER CARTRIDGE

(75) Inventor: Tsutomu Katsumata, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/826,012

(22) Filed: Jun. 29, 2010

Related U.S. Application Data
(60) Provisional application No. 61/223,834, filed on Jul. 8, 2009.

(51) Int. Cl. G03G 15/08

(52) U.S. Cl. 399/12; 399/263

(57) ABSTRACT

According to one embodiment, a toner cartridge includes a cartridge body to contain toner. A stirring member is contained in the cartridge body. The stirring member is rotated in the cartridge body to stir the toner. An indicator section to indicate a state of the toner in the cartridge body is provided on the cartridge body. The indicator section is configured to lead a part of the toner in the cartridge body to the outside of the cartridge body.

### CROSS-REFERENCE TO RELATED APPLICATION

This application claims the benefit of U.S. Provisional Application No. 61/223,834 filed Jul. 8, 2009, the entire contents of which are incorporated herein by reference.

### FIELD

Embodiments described herein relate generally to a toner cartridge that supplies toner to an image forming apparatus.

### BACKGROUND

An image forming apparatus includes a toner cartridge to supply toner to a developing unit. This type of toner cartridge includes a cartridge body to contain toner, a stirring member contained in the cartridge body, and a screw disposed at the bottom of the cartridge body. The cartridge body includes a toner discharge port to discharge toner. The stirring member rotates in the cartridge body to stir the toner so that the toner is not solidified. The screw rotates in the cartridge body to carry the toner to the toner discharge port. Jpn. Pat. Appln. KOKAI Publication No. 2007-310148 discloses the toner cartridge having the structure as stated above.

A new toner cartridge is recommended to be shaken a predetermined number of times before it is mounted to an image forming apparatus and is used. The toner cartridge is shaken so that the toner in the cartridge body is loosened and the fluidity of the toner can be raised. Thus, when the stirring member stirs the toner, the resistance of the toner applied to the stirring member is reduced.

The state of toner in the cartridge body varies according to the storage form and storage period of the toner cartridge. In addition to that, the toner in the cartridge body is sometimes solidified by, for example, the influence of vibration applied at the time of transportation of the toner cartridge. The degree of the solidification of the toner is various. Thus, according to the state of the toner, there can occur a case where the toner is loosened by shaking the toner cartridge only several times and a case where the toner is not sufficiently loosened unless much time is taken to shake the toner cartridge.

However, in the related art toner cartridge, since the cartridge body is made of an opaque black synthetic resin material, the state of the toner in the cartridge body can not be visually recognized from the outside of the cartridge body. Thus, even if the user thinks that the toner cartridge is sufficiently shaken, there can occur a case where the toner is not loosened, and the stirring member is locked. On the other hand, there can occur a case where although the toner is loosened, the toner cartridge is continued to be shaken, and wasteful time and labor are taken for an operation of loosening the toner.

### BRIEF DESCRIPTION OF THE DRAWINGS

FIG. 1 is a side view schematically showing an image forming apparatus of a first embodiment;

FIG. 2 is a perspective view of a toner cartridge of the first embodiment;

FIG. 3 is an exploded perspective view showing the toner cartridge of the first embodiment;

FIG. 4 is a plan view showing a positional relation between a stirring member and a screw contained in a container;

FIG. 5 is a sectional view along line F5-F5 of FIG. 4;

FIG. 6 is a sectional view along line F6-F6 of FIG. 4;

FIG. 7 is a sectional view of an indicator section of the first embodiment;

FIG. 8 is a sectional view along line F8-F8 of FIG. 7;

FIG. 9 is a sectional view showing a state where loosened toner enters a toner inflow pipe when a cover is removed;

FIG. 10 is a sectional view along line F10-F10 of FIG. 9;

FIG. 11 is a sectional view of an indicator section of a second embodiment;

FIG. 12 is a sectional view along line F12-F12 of FIG. 11;

FIG. 13 is a sectional view showing a state where the color of an indicating member is changed by toner permeated in the indicating member when a cover is removed;

FIG. 14 is a sectional view along F14-F14 of FIG. 13;

FIG. 15 is a perspective view of a toner cartridge of a third embodiment;

FIG. 16 is a sectional view of the toner cartridge of the third embodiment; and

FIG. 17 is a sectional view of a toner cartridge of a fourth embodiment.

### DETAILED DESCRIPTION

In general, according to one embodiment, a toner cartridge includes a cartridge body to contain toner. A stirring member is contained in the cartridge body. The stirring member is rotated in the cartridge body to stir the toner. An indicator section to indicate a state of the toner in the cartridge body is provided on the cartridge body. The indicator section is configured to lead a part of the toner in the cartridge body to the outside of the cartridge body.

### First Embodiment

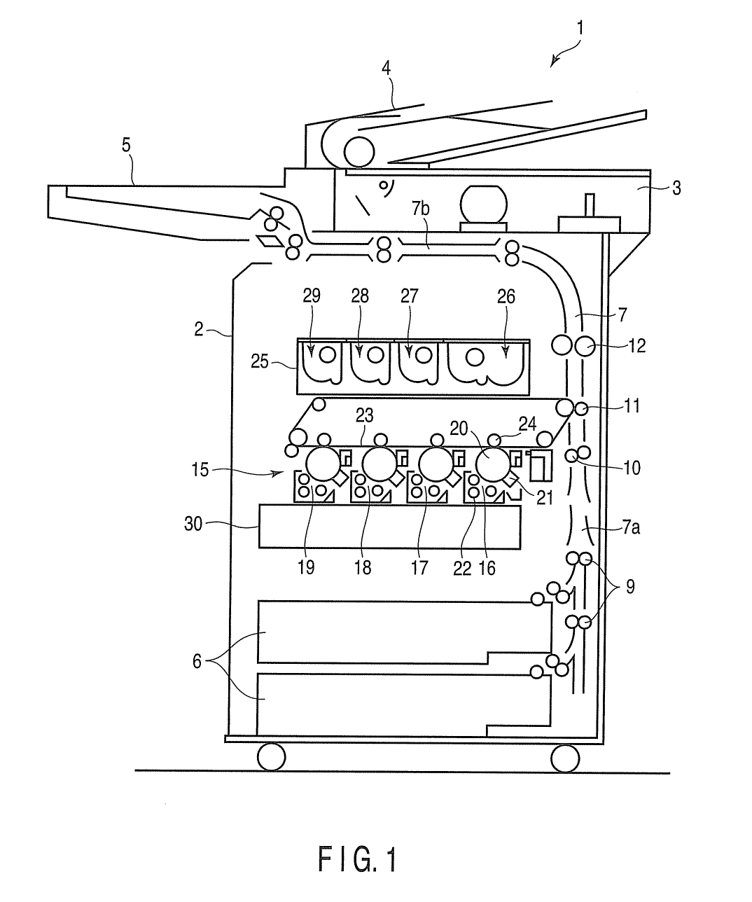

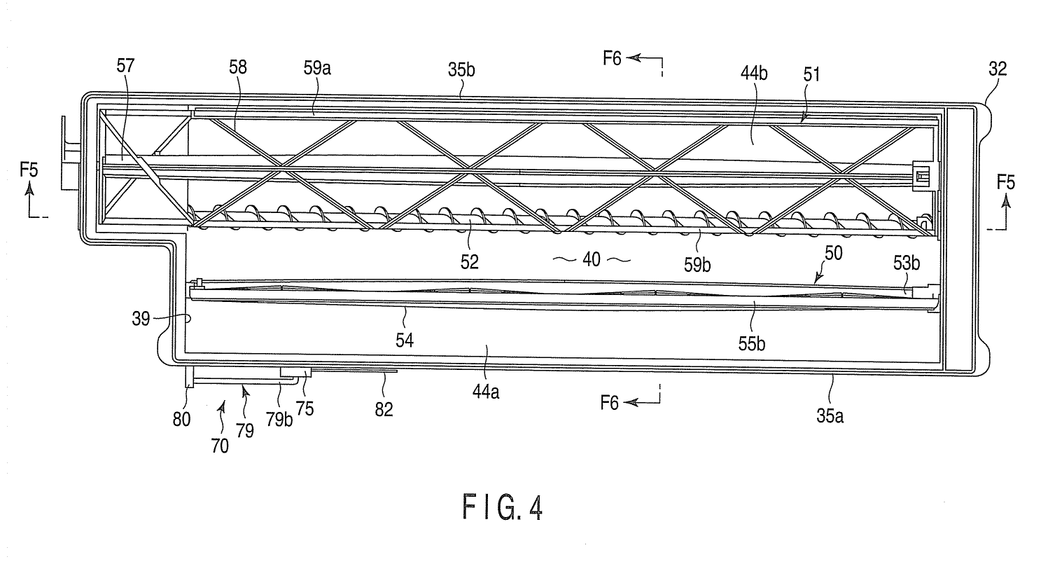

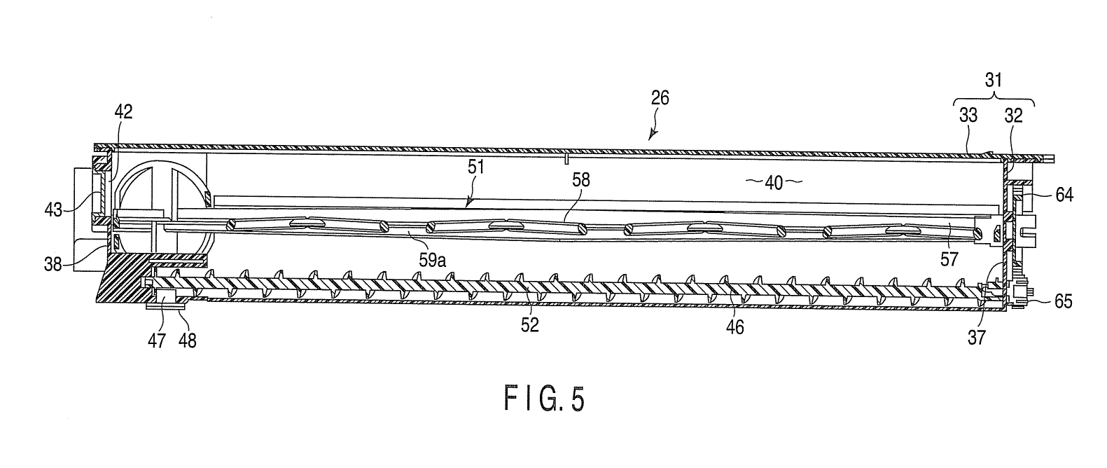

Hereinafter, a first embodiment will be described with reference to FIG. 1 to FIG. 10.

FIG. 1 schematically shows an image forming apparatus 1 such as a four-drum tandem color copy machine. The image forming apparatus 1 includes an apparatus body 2. A scanner 3 to optically read image information such as characters from an original document, an automatic document feeder 4 to feed the original document to the scanner 3, and a paper discharge tray 5 are provided at an upper part of the apparatus body 2.

Plural paper feeding cassettes 6 are provided at a lower part of the apparatus body 2. The paper feeding cassettes 6 are connected to the paper discharge tray 5 through a carrying path 7. The carrying path 7 is for guiding sheets contained in the paper feeding cassettes 6 one by one to the paper discharge tray 5. The carrying path 7 includes a first path 7a and a second path 7b. The first path 7a extends upward from the paper feeding cassettes 6. The second path 7b extends horizontally from the upper end of the first path 7a to the paper discharge tray 5. Plural feeding rollers 9, a registration roller 10, a transfer roller 11 and a fixing unit 12 are provided on the first path 7a in sequence from below.

As shown in FIG. 1, an image forming section 15 is disposed at a middle of the apparatus body 2. The image forming section 15 includes a first image forming unit 16 to form a black image, a second image forming unit 17 to form a cyan image, a third image forming unit 18 to form a magenta image, and a fourth image forming unit 19 to form a yellow image. The first to the fourth image forming units 16 to 19 are arranged in one line along the width direction of the apparatus body 2.

Each of the first to the fourth image forming units 16 to 19 includes a photosensitive drum 20, a charger 21 to charge the outer peripheral surface of the photosensitive drum 20, a developing unit 22 to develop an electrostatic latent image formed on the outer peripheral surface of the photosensitive drum 20 with toner, and an intermediate transfer roller 24 to transfer a toner image on the photosensitive drum 20 to an intermediate transfer belt 23. The intermediate transfer belt 23 passes between the photosensitive drum 20 and the intermediate transfer roller 24 of each of the first to the fourth image forming units 16 to 19, and is pressed to the transfer roller 11.

A cartridge receptacle 25 is disposed above the first to the fourth image forming units 16 to 19. A first to a fourth toner cartridges 26, 27, 28 and 29 are detachably received in the cartridge receptacle 25. The first toner cartridge 26 supplies black toner to the developing unit 22 of the first image forming unit 16. The second toner cartridge 27 supplies cyan toner to the developing unit 22 of the second image forming unit 17. The third toner cartridge 28 supplies magenta toner to the developing unit 22 of the third image forming unit 18. The fourth toner cartridge 29 supplies yellow toner to the developing unit 22 of the fourth image forming unit 19.

A laser unit 30 is disposed below the first to the fourth image forming units 16 to 19. The laser unit 30 irradiates light corresponding to image information to the photosensitive drums 20 of the first to the fourth image forming units 16 to 19. As a result, electrostatic latent images of colors to be developed are formed on the outer peripheral surfaces of the photosensitive drums 20 of the first to the fourth image forming units 16 to 19.

The electrostatic latent images formed on the photosensitive drums 20 of the first to the fourth image forming units 16 to 19 are respectively developed with toners of desired colors on the developing unit 22, and are visualized as toner images. The four color toner images are successively transferred to the intermediate transfer belt 23 by the intermediate transfer rollers 24, and are superimposed on the intermediate transfer belt 23.

When the four color toner images are transferred to the intermediate transfer belt 23, a sheet supplied from one paper feeding cassette 6 to the first path 7a of the carrying path 7 is guided to the position of the intermediate transfer belt 23 by the registration roller 10. The four color toner images superimposed on the intermediate transfer belt 23 are transferred to the sheet by the transfer roller 11. The full-color image transferred to the sheet is fixed to the sheet by the fixing unit 12. The sheet on which the full-color image is fixed is guided to the paper discharge tray 5 through the second path 7b of the carrying path 7.

Next, the first to the fourth toner cartridges 26 to 29 will be described.

In the first toner cartridge 26 filled with black toner, toner consumption is high as compared with the second to the fourth toner cartridges 27 to 29. Thus, the first toner cartridge 26 is constructed so that the filling amount of toner is larger than that of the second to the fourth toner cartridges 27 to 29. In the first to the fourth toner cartridges 27 to 29, a structure for discharging the filled toner is basically the same. Thus, in the first embodiment, the structure of the first toner cartridge 26 will be described as a typical example.

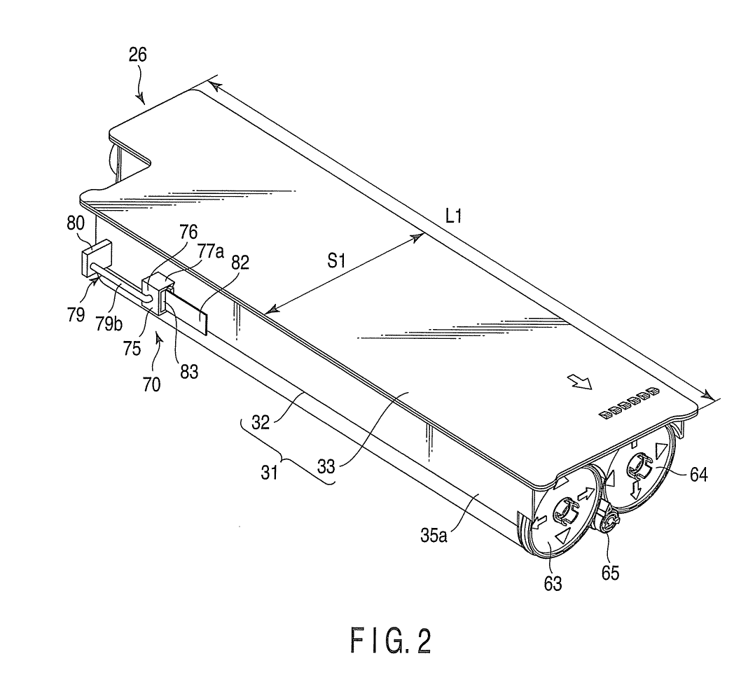

As shown in FIG. 2 to FIG. 5, the first toner cartridge 26 includes a cartridge body 31. The cartridge body 31 is made of, for example, an opaque black synthetic resin material. The cartridge body 31 has a thin and long box shape having a long axis L1 along the depth direction of the image forming apparatus 1 and a short axis S1 along the width direction of the image forming apparatus 1. The cartridge body 31 is detachably inserted into the cartridge receptacle 25 from the front side of the image forming apparatus 1.

The cartridge body 31 includes a container 32 and a cover 33. The container 32 includes a left side wall 35a, a right side wall 35b, a bottom wall 36, a rear wall 37, a front wall 38 and an opening 39. The left side wall 35a and the right side wall 35b extend along the long axis L1 of the cartridge body 31, and are opposite to each other in the direction of the short axis S1. The bottom wall 36 extends between the lower end of the left side wall 35a and the lower end of the right side wall 35b. The rear wall 37 is positioned at one end of the cartridge body 31 along the direction of the long axis L1. The front wall 38 is positioned at the other end of the cartridge body 31 along the direction of the long axis L1. The opening 39 has a rectangular opening shape surrounded by the upper edges of the right and the left side walls 35a and 35b, the upper edge of the rear wall 37, and the upper edge of the front wall 38, and faces the bottom wall 36.

The cover 33 closes the opening 39 of the container 32. The cover 33 defines a toner receptacle 40 to contain black toner in the inside of the cartridge body 31 in cooperation with the container 32. A toner filling port 42 is formed in the front wall 38 of the container 32. The toner filling port 42 is for filling the black toner into the toner receptacle 40. The toner filling port 42 is closed by a cap 43 after filling of the toner is completed.

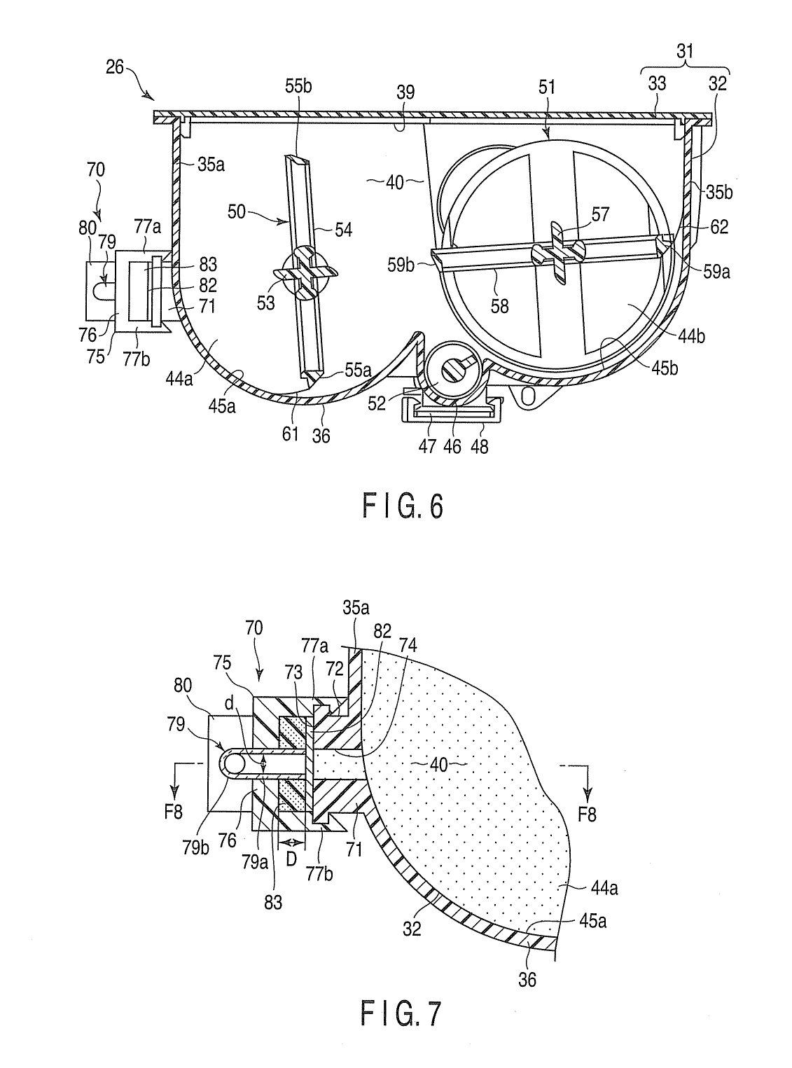

As shown in FIG. 6, the toner receptacle 40 includes a first toner containing area 44a and a second toner containing area 44b. The first and the second toner containing areas 44a and 44b extend along the long axis L1 of the cartridge body 31, and are arranged to be adjacent to each other in the direction of the short axis S1 of the cartridge body 31.

The bottom wall 36 of the container 32 includes a bottom surface 45a corresponding to the first toner containing area 44a, a bottom surface 45b corresponding to the second toner containing area 44b, and a recess 46. The bottom surfaces 45a and 45b are curved like an arc so as to project to the lower part of the container 32. The recess 46 is opened to the toner receptacle 40 between the bottom surfaces 45a and 45b, and extends straight in the direction of the long axis L1 of the cartridge body 31.

The recess 46 includes a toner discharge port 47. The toner discharge port 47 is for discharging the toner contained in the toner receptacle 40 to the outside of the cartridge body 31. The toner discharge port 47 is positioned at an end of the recess 46 adjacent to the front wall 38 of the container 32. Further, a shutter 48 is supported by the bottom wall 36 of the container 32. The shutter 48 is exposed to the outside of the toner cartridge 31, and can be slid between a close position of closing the toner discharge port 47 and an open position of opening the toner discharge port 47.

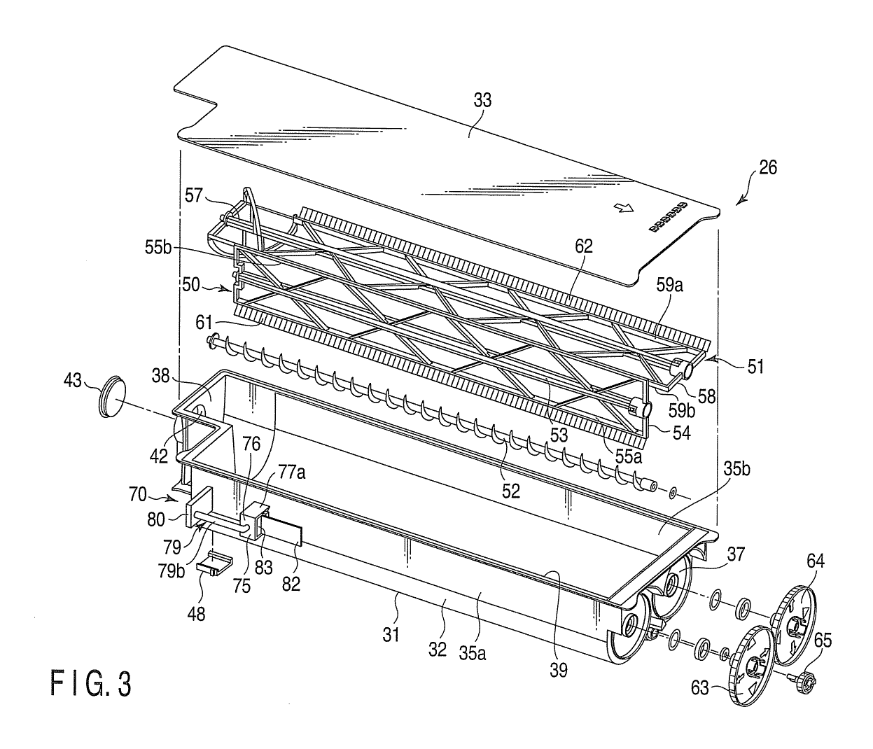

As shown in FIG. 3 to FIG. 6, the first toner cartridge 26 includes a first and a second stirring members 50 and 51 to stir the toner filled in the toner receptacle 40, and a screw 52 to carry the toner filled in the toner receptacle 40 to the toner discharge port 47.

The first stirring member 50 is contained in the first toner containing area 44a. The first stirring member 50 includes a rotation shaft 53 and a paddle 54. The rotation shaft 53 extends between the rear wall 37 and the front wall 38. The paddle 54 includes plural rod-like members constructed like a truss and includes two outer frames 55a and 55b extending in the axial direction of the rotation shaft 53. The first stirring member 50 is supported by the container 32 through the rotation shaft 53, and rotates around the rotation shaft 53. When the first stirring member 50 rotates, the outer frames 55a and 55b of the paddle 54 move along the bottom surface 45a of the toner containing area 44a.

The second stirring member 51 is contained in the second toner containing area 44b. The second stirring member 51 includes a rotation shaft 57 and a paddle 58. The rotation shaft 57 extends between the rear wall 37 and the front wall 38. The paddle 58 includes plural rod-like members constructed like a truss and includes two outer frames 59a and 59b extending in the axial direction of the rotation shaft 57. The second stirring member 51 is supported by the container 32 through the rotation shaft 57, and rotates around the rotation shaft 57. When the second stirring member 51 rotates, the outer frames 59a and 59b of the paddle 58 move along the bottom surface 45b of the second toner containing area 44b.

A scraper 61 having elasticity is fixed to the outer frame 55a of the first stirring member 50. When the first stirring member 50 rotates, the scraper 61 contacts the bottom surface 45a of the first toner containing area 44a. A scraper 62 having elasticity is fixed to the outer frame 59a of the second stirring member 51. When the second stirring member 51 rotates, the scraper 62 contacts the bottom surface 45b of the second toner containing area 44b.

A first gear 63 is coaxially fixed to the rear end of the rotation shaft 53 of the first stirring member 50. Similarly, a second gear 64 is coaxially fixed to the rear end of the rotation shaft 57 of the second stirring member 51. The first and the second gears 63 and 64 are engaged with each other at the outside of the rear wall 37 of the container 32. By this engagement, the first and the second stirring members 50 and 51 synchronously rotate in reverse directions to each other.

The screw 52 is contained in the recess 46 of the container 32 and is exposed to the bottom of the toner receptacle 40. The screw 52 passes over the toner discharge port 47. The screw 52 extends between the rear wall 37 and the front wall 38, and is rotatably supported by the container 32. A drive gear 65 is coaxially fixed to the rear end of the screw 52. The drive gear 65 is engaged with the first gear 63 rotating integrally with the first stirring member 50 at the outside of the rear wall 37 of the container 32. Further, when the first toner cartridge 26 is inserted into the cartridge receptacle 25 of the apparatus body 2, the drive gear 65 is engaged with a coupling of a drive module of the apparatus body 2.

When torque of the drive module is transmitted to the drive gear 65 through the coupling, the screw 52, together with the drive gear 65, rotates. Further, the torque of the drive module is transmitted from the drive gear 65 to the first and the second stirring members 50 and 51 through the first and the second gears 63 and 64. By this, the first and the second stirring members 50 and 51 are rotated following the screw 52. The first and the second stirring members 50 and 51 stir and loosen the toner in the first and the second toner containing areas 44a and 44b, and send the toner to the screw 52. The screw 52 carries the toner sent from the first and the second stirring members 50 and 51 to the toner discharge port 47. The toner carried to the toner discharge port 47 is supplied from the toner discharge port 47 to the developing unit 22 of the first image forming unit 16.

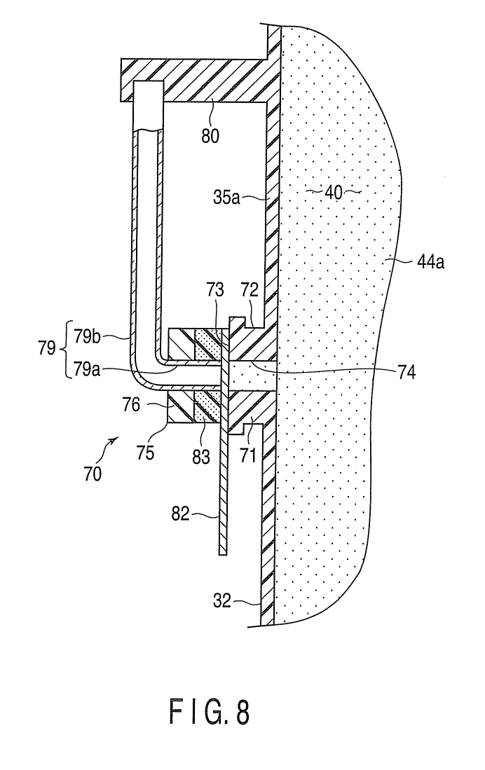

As shown in FIG. 6 and FIG. 8, the first toner cartridge 26 includes an indicator section 70. The indicator section 70 is a component to visually indicate to the outside of the cartridge body 31 that the toner filled in the toner receptacle 40 is loosened, and is provided at the left side wall 35a of the container 32.

As shown in FIG. 7 and FIG. 8, a mounting seat 71 is formed integrally with the left side wall 35a of the container 32. The mounting seat 71 is provided at a position where a distance from the front wall 38 is shorter than a distance from the rear wall 37 of the container 32 and protrudes to the left side of the container 32 from the left side wall 35a.

The mounting seat 71 includes an engagement groove 72, a flat seal surface 73 and a communicating port 74. The engagement groove 72 is formed on the outer peripheral surface of the mounting seat 71. The seal surface 73 is formed at the end of the mounting seat 71 and stands along the left wall 35a of the container 32. The communicating port 74 passes through the center of the mounting seat 71. One end of the communicating port 74 is opened to the first containing area 44a of the toner receptacle 40. The other end of the communicating port 74 is opened at the center of the seal surface 73.

A holder 75 is supported by the mounting seat 71. The holder 75 includes a support wall 76 and a pair of engagement walls 77a and 77b. The support wall 76 has a square plate shape having substantially the same size as the seal surface 73 of the mounting seat 71. The one engagement wall 77a protrudes from the upper edge of the support wall 76 to the left side wall 35a of the container 32. The other engagement wall 77b protrudes from the lower edge of the support wall 76 to the left side wall 35a of the container 32. The ends of the engagement walls 77a and 77b are respectively caught by the engagement groove 72 of the mounting seat 71 and the outer peripheral part of the end of the mounting seat 71. As a result, the holder 75 is held by the mounting seat 71, and the seal surface 73 of the mounting seat 71 and the support wall 76 of the holder 75 face each other with while an interval is provided therebetween.

A toner inflow pipe 79 is supported by the support wall 76 of the holder 75. The toner inflow pipe 79 is an example of a toner inflow section, and is composed of a transparent resin material. The toner inflow pipe 79 includes a first portion 79a and a second portion 79b. The first portion 79a is supported by the support wall 76 so as to pass through the center of the support wall 76. One end of the first portion 79a is opposite to the communicating port 74 on the seal surface 73. The second portion 79b extends from the other end of the first portion 79a in the direction perpendicular to the first portion 79a. Specifically, the second portion 79b extends to the front of the mounting seat 71 along the long axis L1 of the cartridge body 31 at the outside of the left side wall 35a of the container 32. The end of the second portion 79b is supported by a receiving part 80 protruding from the right side wall 35b of the container 32. Thus, the second portion 79b of the toner inflow pipe 79 is exposed to the outside of the cartridge body 31 at a position adjacent to the toner discharge port 47.

Further, the toner inflow pipe 79 has such an inner diameter d that sufficiently loosened toner can enter. The inner diameter d of the toner inflow pipe 79 is made, for example, 0.5 mm to 1.0 mm although it depends on the kind of toner filled in the toner receptacle 40.

As shown in FIG. 7 and FIG. 8, a tape-like cover 82 is superimposed on the seal surface 73. The cover 82 is extended to a rear part of the cartridge body 31 through between the engagement walls 77a and 77b of the holder 75.

A seal member 83 is disposed between the cover 82 and the support wall 76 of the holder 75. The seal member 83 is composed of an elastic body such as a sponge. The seal member 83 is sandwiched between the engagement walls 77a and 77b of holder 75. Further, the seal member 83 is compressed between the cover 82 and the support wall 76, and presses the cover 82 to the seal surface 73. As a result, the other end of the communicating port 74 opened in the seal surface 73 is closed by the cover 82. The seal member 83 has such a thickness D that the cover 82 can be pressed to the seal surface 73 by a sufficient pressure. The thickness D of the seal member 83 is, for example, 1.5 mm to 2.0 mm.

The first portion 79a of the toner inflow pipe 79 supported by the holder 75 passes through the seal member 83. The opening end of the first portion 79a is closed by the cover 82. Thus, the cover 82 intervenes between the first portion 79a of the toner inflow pipe 79 and the communicating port 74, and interrupts the communication between the toner inflow pipe 79 and the communicating port 74.

At the stage before the first toner cartridge 26 is mounted to the image forming apparatus 1, as shown in FIG. 7 and FIG. 8, the communicating port 74 of the cartridge body 31 is closed by the tape-like cover 82. Thus, the toner is retained in the toner receptacle 40, and the toner inflow pipe 79 keeps the colorless transparent state.

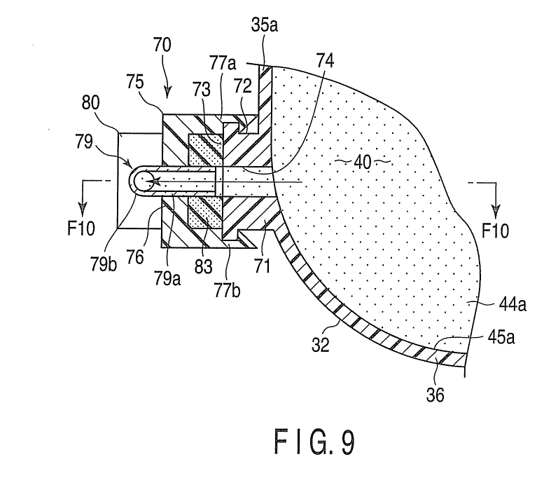

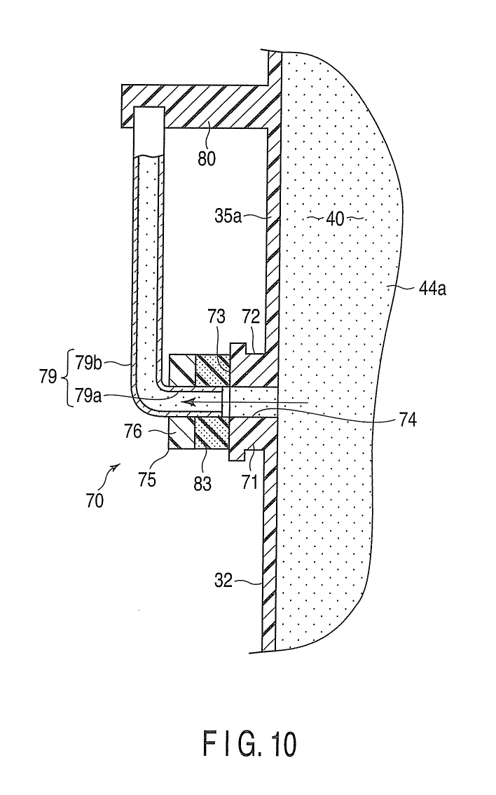

The tape-like cover 82 is removed from the seal surface 73 before the first toner cartridge 26 is shaken. Specifically, the end of the cover 82 extended to the rear part of the cartridge body 31 from the holder 75 is pinched and pulled by fingers, and the cover 82 is pulled out from between the seal surface 73 and the seal member 83. As shown in FIG. 9 and FIG. 10, when the cover 82 is pulled out, the communicating port 74 communicates with the toner inflow pipe 79. Besides, the seal member 83 expands and elastically comes in close contact with the seal surface 73, and surrounds and seals the communicating portion between the communicating port 74 and the toner inflow pipe 79. Thus, even if the communicating port 74 is opened, the toner in the toner receptacle 40 does not leak from the communicating port 74 to the outside of the cartridge body 31.

The first toner cartridge 26 is shaken after the cover 82 is pulled out. The first toner cartridge 26 is shaken, so that the toner in the toner receptacle 40 is loosened and the fluidity of the toner is increased. Thus, as indicated by an arrow in FIG. 9 and FIG. 10, a part of the loosened toner in the toner receptacle 40 enters the first portion 79a and the second portion 79b of the toner inflow pipe 79 from the communicating port 74. Thus, the second portion 79b of the toner inflow pipe 79 exposed to the outside of the cartridge body 31 becomes black. As a result, the user who shakes the first toner cartridge 26 can visually recognize from the outside of the cartridge body 31 that the toner in the toner receptacle 40 is sufficiently loosened.

The inventor engaged in the development of the first toner cartridge 26 prepared sample 1 to sample 6 different in the inner diameter d of the toner inflow pipe 79 and the thickness D of the seal member 83, and inspected each of the sample 1 to the sample 6 as to whether toner was leaked and whether there was a defect in the supply of toner. Table 1 shows the inspection results of the sample 1 to the sample 6.

TABLE 1

| | Inner diameter | Thickness | Defect | Leakage |
|---|---|---|---|---|
| | d (mm) of toner | D (mm) of | in supply | of |
| | inflow pipe | seal member | of toner | toner |
| Sample 1 | 0.5 | 1.5 | NO | NO |
| Sample 2 | 1.5 | 1.5 | NO | NO |
| Sample 3 | 1.0 | 2.0 | NO | NO |
| Sample 4 | 2.0 | 1.0 | YES | YES |
| Sample 5 | 1.0 | 1.0 | NO | YES |
| Sample 6 | 0.4 | 1.5 | YES | NO |

As is apparent from Table 1, in the samples 1 to 3 and 5 in which the inner diameter d of the toner inflow pipe 79 is within the range of 0.5 mm to 1.0 mm, toner is properly supplied from the toner discharge port 47. On the other hand, in the sample 6 in which the inner diameter d of the toner inflow pipe 79 is 0.4 mm and the sample 4 in which the inner diameter d of the toner inflow pipe 79 is 2.0 mm, a defect occurs in the supply of toner. As a result of investigation, the reason appears to be as follows. In the sample 6 in which the inner diameter d of the toner inflow pipe 79 is 0.4 mm, the toner inflow pipe 79 is so thin that clogging occurs in the toner inflow pipe 79, and it is impossible to visually indicate to the outside of the cartridge body 31 that the toner is loosened. Further, in the sample 4 in which the inner diameter d of the toner inflow pipe 79 is 2.0 mm, the toner inflow pipe 79 is so thick that the toner not sufficiently loosened enters the inside of the toner inflow pipe 79, and the user has an illusion that the shaking of toner is completed.

On the other hand, in the sample 4 and the sample 5 in which the thickness D of the seal member 83 is 1.0 mm, toner leakage occurs. It appears that the reason is that the elasticity of the seal member 83 is insufficient, and a gap occurs between the seal member 83 and the seal surface 73.

Accordingly, in order to cause the user to visually recognize that toner is loosened while the leakage of toner is prevented, the inner diameter d of the toner inflow pipe 79 is made 0.5 mm to 1.5 mm, and the thickness D of the seal member 83 is made at least 1.5 mm or more.

According to the first embodiment, it is possible to visually recognize from the outside of the cartridge body 31 that the toner in the cartridge body 31 is sufficiently loosened. Thus, it is possible to prevent that the first toner cartridge 26 in which toner is not sufficiently loosened is mounted to the image forming apparatus 1, and the lock of the first and the second stirring members 50 and 51 can be avoided.

Further, it is possible to avoid a wasteful operation that the first toner cartridge 26 is continued to be shaken although the toner is loosened. Thus, time and labor when the toner is loosened can be reduced.

### Second Embodiment

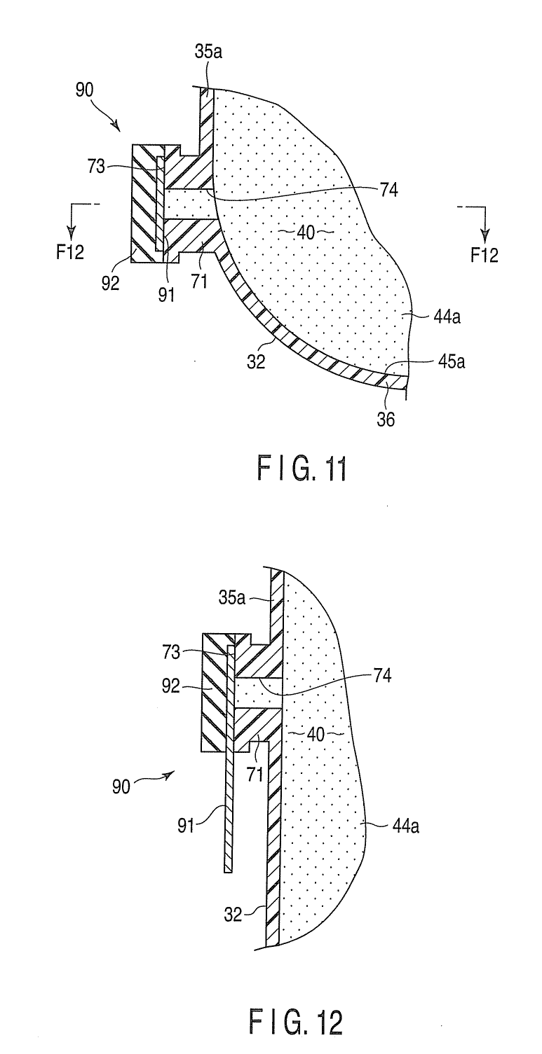

FIG. 11 to FIG. 14 show a second embodiment.

The second embodiment is different from the first embodiment in the structure of an indicator section to visually indicate that toner in a cartridge body is sufficiently loosened. The structure of a toner cartridge is the same as that of the first embodiment. Thus, in the second embodiment, the same component as that of the first embodiment is denoted by the same reference numeral and its description is omitted.

As shown in FIG. 11, an indicator section 90 provided on a left side wall 35a of a cartridge body 31 includes a mounting seat 71 having a communicating port 74, a tape-like cover 91 and an indicating member 92. The cover 91 is superimposed on a seal surface 73 of the mounting seat 71. The cover 91 is extended to a rear part of the cartridge body 31 from the seal surface 73.

The indicating member 92 is composed of a porous material into which the loosened toner can permeate, and has a size coincident with the seal surface 73. As the porous material, it is desirable to use an elastically deformable sponge. The foaming rate and thickness of the sponge can be changed according to the kind of the toner. It is desirable that the color of the sponge is, for example, a whitish color paler than toner black.

The outer peripheral part of the indicating member 92 projects to the periphery of the cover 91 on the seal surface 73, and is fixed to the seal surface 73 by a measure such as adhesion. Thus, the cover 91 is pressed to the seal surface 73 by the indicating member 92 and closes the communicating port 74 opening to the seal surface 73.

At the stage before the first toner cartridge 26 is mounted to the image forming apparatus, the communicating port 74 of the cartridge body 31 is closed by the tape-like cover 91. Thus, the toner is retained in the toner receptacle 40, and the indicating member 92 keeps the white color state.

The tape-like cover 91 is removed from the seal surface 73 before the first toner cartridge 26 is shaken. Specifically, the end of the cover 91 extended to the rear part of the cartridge body 31 from the mounting seat 71 is pinched and pulled by fingers, and the cover 91 is pulled out from between the seal surface 73 and the indicating member 92. When the cover 91 is pulled out, the center of the indicating member 92 faces the communicating port 74, and the center of the indicating member 92 expands and elastically comes in close contact with the seal surface 73. Thus, the communicating port 74 is closed by the indicating member 92, and the toner in the toner receptacle 40 does not leak from the communicating port 74 to the outside of the cartridge body 31.

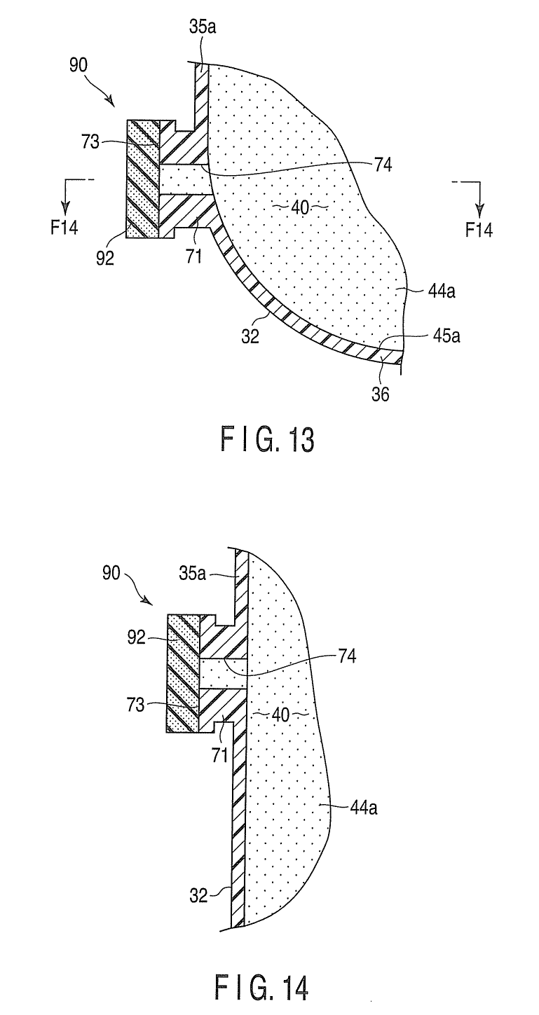

When the first toner cartridge 26 is shaken after the cover 91 is pulled out, the toner in the toner receptacle 40 is loosened and the fluidity of the toner is increased. Thus, as shown in FIG. 13 and FIG. 14, a part of the toner loosened in the toner receptacle 40 is led from the communicating port 74 to the indicating member 92. The toner reaching the indicating member 92 permeates into the porous indicating member 92. Thus, the color of the indicating member 92 becomes black. As a result, the user who shakes the first toner cartridge 26 can visually recognize from the outside of the cartridge body 31 that the toner in the toner receptacle 40 is sufficiently loosened.

Also in the second embodiment, it is possible to visually recognize from the outside of the cartridge body 31 that the toner in the cartridge body 31 is sufficiently loosened. Accordingly, the same effects as those of the first embodiment can be obtained.

### Third Embodiment

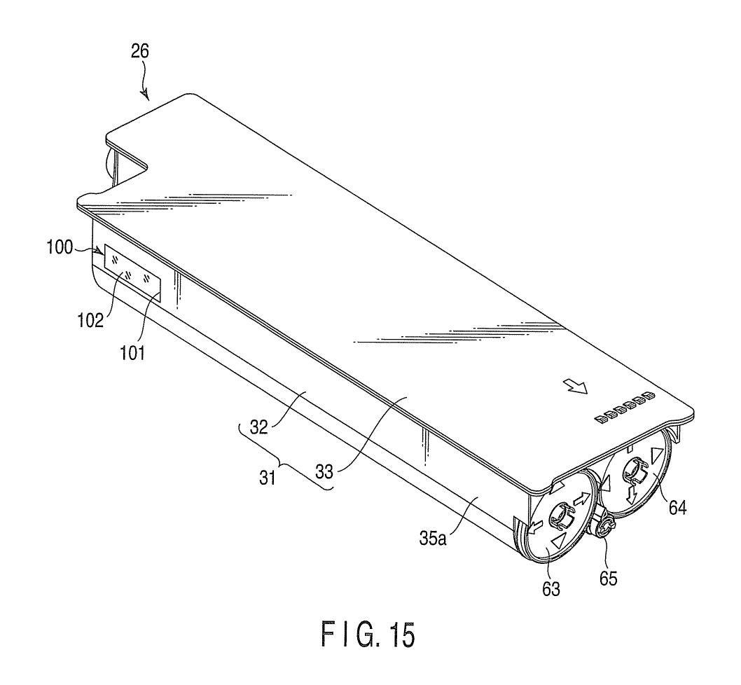

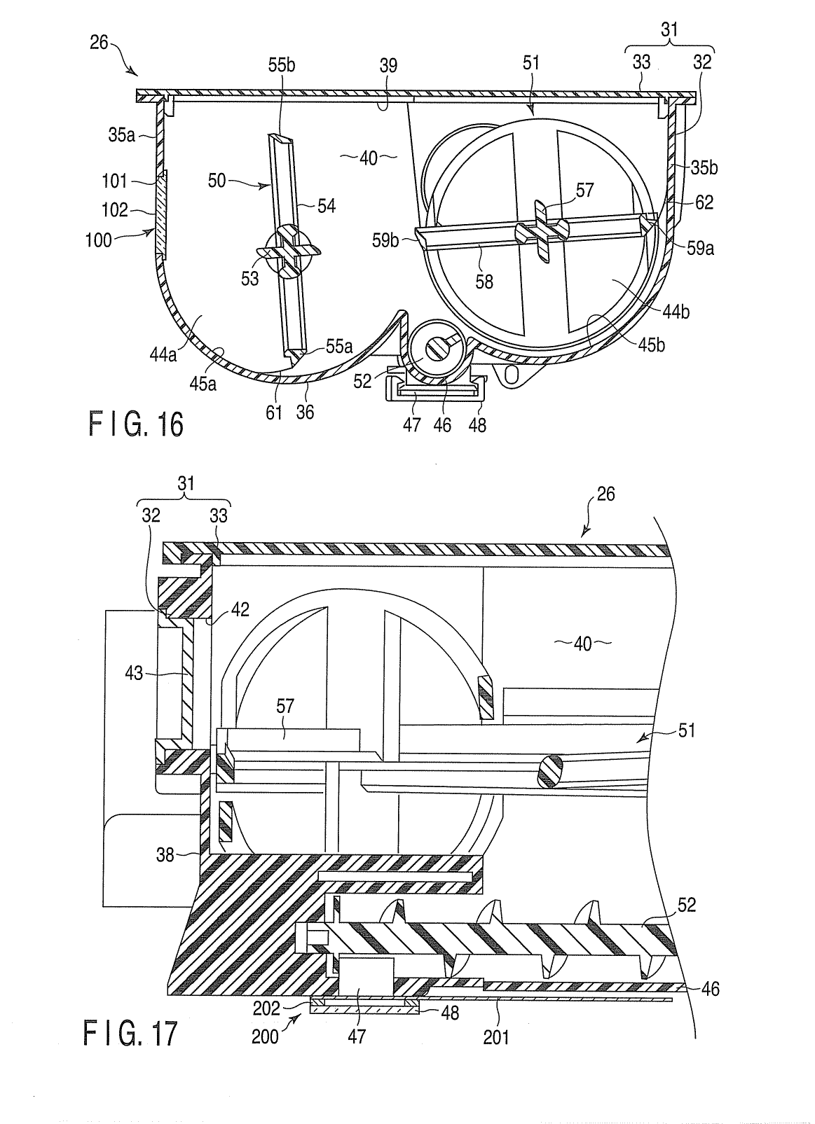

FIG. 15 and FIG. 16 show a third embodiment. The third embodiment is different from the first embodiment in the structure of an indicator section to visually indicate that toner in a cartridge body is sufficiently loosened. The structure of a toner cartridge is the same as that of the first embodiment. Thus, in the third embodiment, the same component as that of the first embodiment is denoted by the same reference numeral and its description is omitted.

As shown in FIG. 15 and FIG. 16, an indicator section 100 includes an opening 101 opened in a left side wall 35a of a cartridge body 31, and a transparent plate 102 to close the opening 101. The transparent plate 102 is composed of, for example, a transparent acrylic plate.

According to the third embodiment, by the existence of the transparent plate 102, a part of the left side wall 35a of the opaque cartridge body 31 is transparent. Thus, the state of the inside of the cartridge body 31 can be visually recognized from the outside of the cartridge body 31 through the transparent plate 102. As a result, it is possible to visually recognize that the toner in the cartridge body 31 is sufficiently loosened.

### Fourth Embodiment

FIG. 17 shows a fourth embodiment. The fourth embodiment is different from the first embodiment in the structure of an indicator section to visually indicate that toner in a cartridge body is sufficiently loosened. The structure of a toner cartridge is the same as that of the first embodiment. Thus, in the fourth embodiment, the same component as that of the first embodiment is denoted by the same reference numeral and its description is omitted.

As shown in FIG. 17, an indicator section 200 includes a shutter 48 to open and close a toner discharge port 47, and a tape-like cover 201. The shutter 48 is composed of, for example, a transparent acrylic plate. The cover 201 is superimposed on the outer surface of a recess 46 of a container 32, and covers the toner discharge port 47 from below the container 32. The cover 201 intervenes between the toner discharge port 47 and the shutter 48, and is extended to a rear part of the cartridge body 31 from the opening end of the toner discharge port 47.

The ring-shaped seal member 202 is fixed to an upper surface of the shutter 48 by a measure such as adhesion. The seal member 202 is composed of an elastic body such as a sponge or rubber, and surrounds the toner discharge port 47 when the shutter 48 closes the toner discharge port 47. Thus, the cover 201 is pressed to the outer surface of the bottom wall 36 of the container 32 by the seal member 202, and closes the toner discharge port 47.

At the stage before the first toner cartridge 26 is mounted to the image forming apparatus, the toner discharge port 47 of the cartridge body 31 is closed by the shutter 48 and the tape-like cover 201. Thus, the toner is retained in the toner receptacle 40, and the black toner does not adhere to the transparent shutter 48.

The tape-like cover 201 is removed from the opening end of the toner discharge port 47 before the first toner cartridge 26 is shaken. Specifically, the end of the cover 201 extended to the rear part of the cartridge body 31 from the opening end of the toner discharge port 47 is pinched and pulled by fingers, and the cover 201 is pulled out from between the toner discharge port 47 and the shutter 48. When the cover 201 is pulled out, the center of the shutter 48 faces the toner discharge port 47, and the seal member 202 expands and elastically comes in close contact with the recess 46 of the container 32 at the periphery of the toner discharge port 47. Thus, the toner in the toner receptacle 40 does not leak from the toner discharge port 47 to the outside of the cartridge body 31.

When the first toner cartridge 26 is shaken after the cover 201 is pulled out, the toner in the toner receptacle 40 is loosened and the fluidity of the toner is increased. Thus, a part of the toner loosened in the toner receptacle 40 falls from the toner discharge port 47, and adheres to the shutter 48. Since the shutter 48 is composed of a transparent acrylic plate, it is possible to visually recognize from the outside of the cartridge body 31 that the toner adheres to the shutter 48.

In other words, when the toner adheres to the transparent shutter 48, the color of the shutter 48 becomes black. As a result, the user who shakes the first toner cartridge 26 can visually recognize from the outside of the cartridge body 31 that the toner in the toner cartridge 40 is sufficiently loosened.

In the first to the fourth embodiments, the toner receptacle of the cartridge body includes the first and the second toner containing areas, and the first and the second stirring members are contained in the first and the second containing areas. However, the structure of the toner cartridge is not limited to the first to the fourth embodiments, and for example, one stirring member may be contained in one toner containing area.

Further, the indicator section is not limited to be provided at the position adjacent to the toner discharge port. For example, the indicator section may be provided at a rear end of a cartridge body far from a toner discharge port.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A toner cartridge comprising:
a cartridge body to contain toner;
a stirring member contained in the cartridge body and rotated in the cartridge body to stir the toner; and
an indicator section to indicate a state of the toner in the cartridge body and configured to lead a part of the toner in the cartridge body to an outside of the cartridge body.

2. The toner cartridge of claim 1, wherein the indicator section includes a communicating port opened in the cartridge body; a transparent toner inflow section into which the toner loosened in the cartridge body flows from the communicating port and which is exposed to the outside of the cartridge body; and a cover to close the communicating port, and when the cover is removed from the communicating port, the toner loosened in the cartridge body flows into the toner inflow section from the communicating port.

3. The toner cartridge of claim 2, wherein the cartridge body includes a side wall to define a toner receptacle, and the toner inflow section extends along the side wall at the outside the cartridge body.

4. The toner cartridge of claim 3, further comprising a seal member to surround a communicating portion between the communicating port and the toner inflow section and to prevent leakage of the toner when the cover is removed.

5. The toner cartridge of claim 4, wherein the side wall of the cartridge body has a seal surface in which the communicating port is opened, and the cover is sandwiched between the seal surface and the seal member, and is pressed to the seal surface by the seal member.

6. The toner cartridge of claim 5, wherein the toner inflow section includes a transparent pipe having one end opposite to the communicating port, and the one end of the pipe passes through the seal member.

7. The toner cartridge of claim 6, wherein the seal member is elastically pressed to the seal surface when the cover is removed, and prevents the toner from leaking from between the communicating port and the one end of the pipe.

8. The toner cartridge of claim 1, wherein the cartridge body includes a toner discharge port to discharge the toner, and the indicator section is provided at a position adjacent to the toner discharge port.

9. The toner cartridge of claim 1, wherein the indicator section includes a communicating port opened in the cartridge body; an indicating member into which the toner loosened in the cartridge body permeates and which is exposed to the outside of the cartridge body to cover the communicating port from the outside of the cartridge body; and a cover which intervenes between the cartridge body and the indicating member and closes the communicating port, and the toner loosened in the cartridge body permeates into the indicating member from the communicating port by removing the cover from the communicating port.

10. The toner cartridge of claim 9, wherein the indicating member changes color when the toner permeates.

11. The toner cartridge of claim 1, wherein the cartridge body includes a toner discharge port to discharge the toner, the indicator section includes a transparent shutter to open and close the toner discharge port from the outside of the cartridge body, and a cover which intervenes between the shutter and the toner discharge port and closes the toner discharge port, and when the cover is removed from the toner discharge port, the toner loosened in the cartridge body adheres to the shutter through the toner discharge port.

12. A toner cartridge comprising:
an opaque cartridge body to contain toner;
a stirring member contained in the cartridge body and rotated in the cartridge body to stir the toner; and
an indicator section to visually indicate to an outside of the cartridge body that the toner in the cartridge body is loosened when the cartridge body is shaken, the indicator section includes (i) a communicating port opened in the cartridge body, (ii) a transparent pipe into which the toner loosened in the cartridge body flows from the communicating port and which is exposed to the outside of the cartridge body, and (iii) a cover to close the communicating port, and when the cover is removed from the communicating port, the toner loosened in the cartridge body flows into the pipe from the communicating port.

13. The toner cartridge of claim 12, wherein the cartridge body includes a side wall to define a toner receptacle, and the pipe extends along the side wall at the outside the cartridge body.

14. The toner cartridge of claim 13, further comprising a seal member to surround a communicating portion between the communicating port and the pipe and to prevent the toner from leaking when the cover is removed.

15. The toner cartridge of claim 12, wherein the cartridge body includes a toner discharge port to discharge the toner, and the indicator section is provided at a position adjacent to the toner discharge port.

16. A toner cartridge comprising:
an opaque cartridge body to contain toner;
a stirring member contained in the cartridge body and rotated in the cartridge body to stir the toner; and
an indicator section to visually indicate to an outside of the cartridge body that the toner in the cartridge body is loosened when the cartridge body is shaken, the indicator section includes (i) a communicating port opened in the cartridge body, (ii) an indicating member into which the toner loosened in the cartridge body permeates and which is exposed to the outside of the cartridge body to cover the communicating port from the outside of the cartridge body, and (iii) a cover which intervenes between the cartridge body and the indicating member and closes the communicating port, and when the cover is removed from the communicating port, the toner loosened in the cartridge body permeates into the indicating member from the communicating port.

17. The cartridge of claim 16, wherein the indicating member changes color by permeation of the toner.

18. The cartridge of claim 17, wherein the cartridge body includes a toner discharge port to discharge the toner, and the indicator section is provided at a position adjacent to the toner discharge port.
